(19) United States
(12) Patent Application Publication
(10) Pub. No.: US 2019/0126620 A1
(43) Pub. Date: May 2, 2019

(54) LIQUID JET HEAD AND LIQUID JET RECORDING DEVICE

(71) Applicant: SII Printek Inc., Chiba-shi (JP)

(72) Inventors: Yuki YAMAMURA, Chiba-shi (JP); Masaru MIDORIKAWA, Chiba-shi (JP); Naohiro TOMITA, Chiba-shi (JP); Shunsuke YAMAZAKI, Chiba-shi (JP); Emiko OSAKA, Chiba-shi (JP); Shuji SATO, Chiba-shi (JP)

(21) Appl. No.: 16/176,681

(22) Filed: Oct. 31, 2018

(30) Foreign Application Priority Data
Nov. 2, 2017 (JP) 2017-212910

(51) Int. Cl. B41J 2/16; B41J 2/14

(52) U.S. Cl. CPC B41J 2/1623; B41J 2/14209; B41J 2/1433

(57) ABSTRACT

There are provided a liquid jet head and a liquid jet recording device capable of reducing the cost. A liquid jet head according to an embodiment of the disclosure includes a nozzle plate provided with a nozzle, an actuator disposed so as to be opposed to the nozzle plate, and having a channel communicated with the nozzle and an electrode disposed on a wall surface of the channel, and an adhesive layer disposed between the actuator and the nozzle plate, and including a plurality of insulating particles.

### RELATED APPLICATIONS

This application claims priority under 35 U.S.C. § 119 to Japanese Patent Application No. 2017-212910 filed on Nov. 2, 2017, the entire content of which is hereby incorporated by reference.

### BACKGROUND OF THE INVENTION

### 1. Field of the Invention

The present disclosure relates to a liquid jet head and a liquid jet recording device.

### 2. Description of the Related Art

As one of liquid jet recording devices, there is provided an inkjet type recording device for ejecting (jetting) ink (liquid) on a recording target medium such as recording paper to perform recording of images, characters, and so on.

In the liquid jet recording device of this type, it is arranged that the ink is supplied from an ink tank to an inkjet head (a liquid jet head), and then the ink is ejected from nozzles of the inkjet head toward the recording target medium to thereby perform recording of the images, the characters, and so on.

The liquid jet head described above has a plurality of plates. The plurality of plates is bonded to each other with adhesive layers (see, e.g., JP-A-2008-189728).

It is desired for such a liquid jet head to more simply be manufactured to thereby reduce the cost. Therefore, it is desirable to provide a liquid jet head and a liquid jet recording device which can more simply be manufactured to thereby reduce the cost.

### SUMMARY OF THE INVENTION

A liquid jet head according to an embodiment of the disclosure includes a nozzle plate provided with a nozzle, an actuator disposed so as to be opposed to the nozzle plate, and having a channel communicated with the nozzle and an electrode disposed on a wall surface of the channel, and an adhesive layer disposed between the actuator and the nozzle plate, and including a plurality of insulating particles.

A liquid jet recording device according to an embodiment of the disclosure is equipped with the liquid jet head according to an embodiment of the disclosure.

According to the liquid jet head and the liquid jet recording device related to an embodiment of the disclosure, it becomes possible to more simply manufacture the liquid jet head and the liquid jet recording device to thereby reduce the cost.

### BRIEF DESCRIPTION OF THE DRAWINGS

FIG. 1 is a schematic perspective view showing a schematic configuration example of a liquid jet recording device according to an embodiment of the disclosure.

FIG. 2 is a schematic diagram showing a configuration example of the circulation mechanism and so on shown in FIG. 1.

FIG. 3 is an exploded perspective view showing a detailed configuration example of the liquid jet head shown in FIG. 2.

FIG. 4 is a schematic bottom view showing a configuration example of the liquid jet head in the state in which the nozzle plate shown in FIG. 3 is detached.

FIG. 5 is a schematic diagram showing a cross-sectional configuration example along the line II-II shown in FIG. 4.

FIG. 6 is a schematic diagram showing a cross-sectional configuration of a substantial part of a liquid jet head related to a comparative example.

FIG. 7A is a schematic diagram showing Another Example (1) of the cross-sectional configuration of the insulating particle shown in FIG. 5.

FIG. 7B is a schematic diagram showing Another Example (2) of the cross-sectional configuration of the insulating particle shown in FIG. 5.

FIG. 7C is a schematic diagram showing Another Example (3) of the cross-sectional configuration of the insulating particle shown in FIG. 5.

### DETAILED DESCRIPTION OF THE PREFERRED EMBODIMENTS

An embodiment of the present disclosure will hereinafter be described in detail with reference to the drawings.

### 1. Embodiment

### [Overall Configuration of Printer 1]

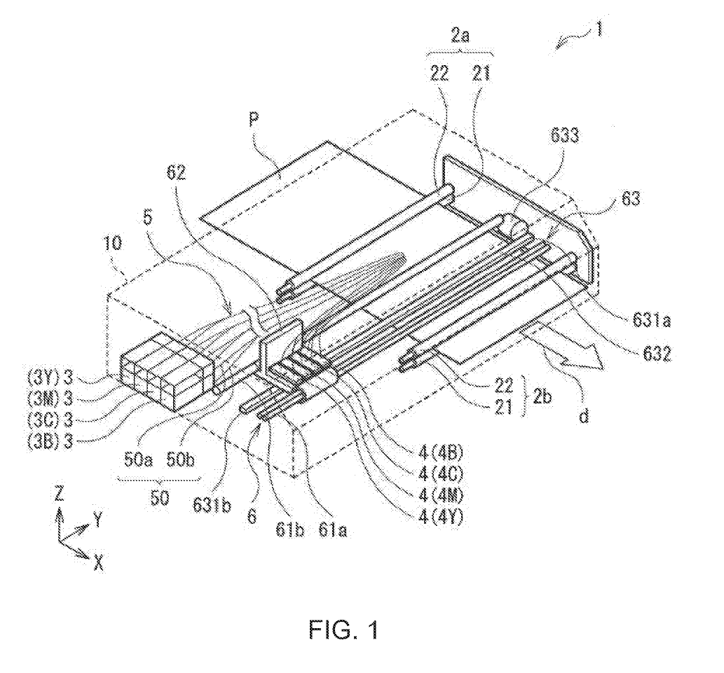

FIG. 1 is a perspective view schematically showing a schematic configuration example of a printer 1 as a liquid jet recording device according to one embodiment of the present disclosure. The printer 1 is an inkjet printer for performing recording (printing) of images, characters, and so on, on recording paper P as a recording target medium using ink 9 described later. Although the details will be described later, the printer 1 is also an ink circulation type inkjet printer using the ink 9 while circulating the ink 9 through a predetermined flow channel.

As shown in FIG. 1, the printer 1 is provided with a pair of carrying mechanisms 2a, 2b, ink tanks 3, inkjet heads 4, a circulation mechanism 5, and a scanning mechanism 6. These members are housed in a housing 10 having a predetermined shape. It should be noted that the scale size of each member is accordingly altered so that the member is shown large enough to recognize in the drawings used in the description of the specification.

Here, the printer 1 corresponds to a specific example of the “liquid jet recording device” in the present disclosure, and the inkjet heads 4 (the inkjet heads 4Y, 4M, 4C, and 4B described later) each correspond to a specific example of the “liquid jet head” in the present disclosure.

The carrying mechanisms 2a, 2b are each a mechanism for carrying the recording paper P along the carrying direction d (an X-axis direction) as shown in FIG. 1. These carrying mechanisms 2a, 2b each have a grit roller 21, a pinch roller 22 and a drive mechanism (not shown). The grit roller 21 and the pinch roller 22 are each disposed so as to extend along a Y-axis direction (the width direction of the recording paper P). The drive mechanism is a mechanism for rotating (rotating in a Z-X plane) the grit roller 21 around an axis, and is constituted by, for example, a motor.

### (Ink Tanks 3)

The ink tanks 3 are each a tank for containing the ink 9 inside. As the ink tanks 3, there are disposed 4 types of tanks for individually containing 4 colors of ink 9, namely yellow (Y), magenta (M), cyan (C), and black (B), in this example as shown in FIG. 1. Specifically, there are disposed the ink tank 3Y for containing the yellow ink 9, the ink tank 3M for containing the magenta ink 9, the ink tank 3C for containing the cyan ink 9, and the ink tank 3B for containing the black ink 9. These ink tanks 3Y, 3M, 3C, and 3B are arranged side by side along the X-axis direction inside the housing 10.

It should be noted that the ink tanks 3Y, 3M, 3C, and 3B have the same configuration except the color of the ink 9 contained, and are therefore collectively referred to as ink tanks 3 in the following description.

### (Inkjet Heads 4)

The inkjet heads 4 are each a head for jetting (ejecting) the ink 9 having a droplet shape from a plurality of nozzles (nozzle holes H1, H2) described later to the recording paper P to thereby perform recording of images, characters, and so on. As the inkjet heads 4, there are also disposed 4 types of heads for individually jetting the 4 colors of ink 9 respectively contained by the ink tanks 3Y, 3M, 3C, and 3B described above in this example as shown in FIG. 1. Specifically, there are disposed the inkjet head 4Y for jetting the yellow ink 9, the inkjet head 4M for jetting the magenta ink 9, the inkjet head 4C for jetting the cyan ink 9, and the inkjet head 4B for jetting the black ink 9. These inkjet heads 4Y, 4M, 4C, and 4B are arranged side by side along the Y-axis direction inside the housing 10.

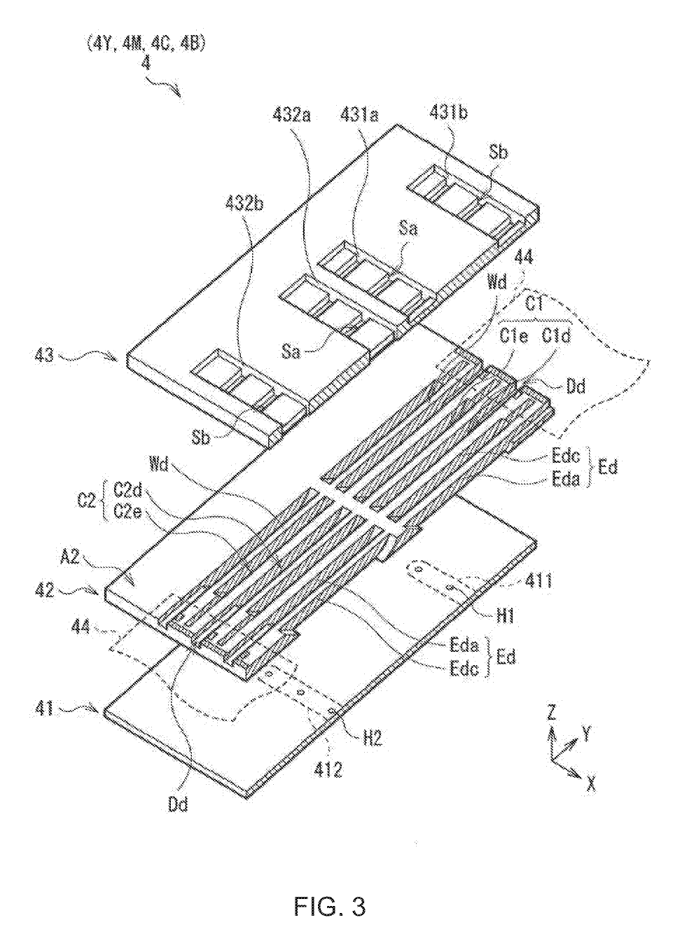

It should be noted that the inkjet heads 4Y, 4M, 4C, and 4B have the same configuration except the color of the ink 9 used, and are therefore collectively referred to as inkjet heads 4 in the following description. Further, the detailed configuration of the inkjet heads 4 will be described later (FIG. 3 through FIG. 5).

### (Circulation Mechanism 5)

The circulation mechanism 5 is a mechanism for circulating the ink 9 between the inside of the ink tanks 3 and the inside of the inkjet heads 4, and is configured including circulation channels 50 of the ink 9.

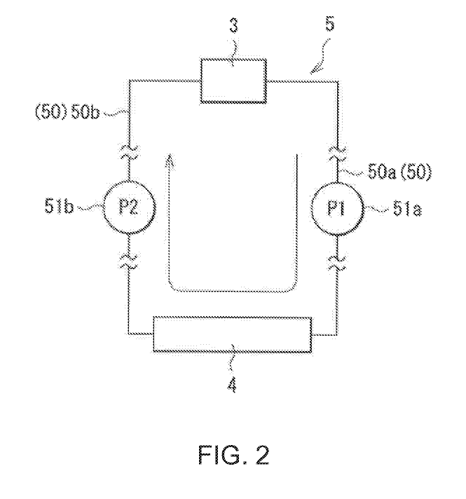

FIG. 2 schematically shows a configuration of the circulation mechanism 5. The circulation channels 50 of the circulation mechanism 5 each have, for example, a flow channel 50a as a part extending from the ink tank 3 to the inkjet head 4, and a flow channel 50b extending from the inkjet head 4 to the ink tank 3. In other words, the flow channel 50a is a flow channel through which the ink 9 flows from the ink tank 3 toward the inkjet head 4. Further, the flow channel 50b is a flow channel through which the ink 9 flows from the inkjet head 4 toward the ink tank 3. The flow channels 50a, 50b (supply tubes of the ink 9) are each formed of a flexible hose having flexibility.

The circulation mechanism 5 has pressure pumps 51a and suction pumps 51b. The pressure pump 51a is a pump provided to the flow channel 50a and for pressurizing the inside of the flow channel 50a to deliver the ink 9 to the inkjet head 4. The suction pump 51b is provided to the flow channel 50b, and depressurizing the inside of the flow channel 50b to suction the ink 9 from the inkjet head 4.

### (Scanning Mechanism 6)

The scanning mechanism 6 is a mechanism for making the inkjet heads 4 perform a scanning operation along the width direction (the Y-axis direction) of the recording paper P. As shown in FIG. 1, the scanning mechanism 6 has a pair of guide rails 61a, 61b disposed so as to extend along the Y-axis direction, a carriage 62 movably supported by these guide rails 61a, 61b, and a drive mechanism 63 for moving the carriage 62 along the Y-axis direction. Further, the drive mechanism 63 is provided with a pair of pulleys 631a, 631b disposed between the pair of guide rails 61a, 61b, an endless belt 632 wound between the pair of pulleys 631a, 631b, and a drive motor 633 for rotationally driving the pulley 631a.

The pulleys 631a, 631b are respectively disposed in areas corresponding to the vicinities of both ends in each of the guide rails 61a, 61b along the Y-axis direction. To the endless belt 632, there is connected the carriage 62. On the carriage 62, there are disposed the four types of inkjet heads 4Y, 4M, 4C, and 4B arranged side by side along the Y-axis direction.

It should be noted that it is arranged that a moving mechanism for moving the inkjet heads 4 relatively to the recording paper P is constituted by such a scanning mechanism 6 and the carrying mechanisms 2a, 2b described above.

### [Detailed Configuration of Inkjet Heads 4]

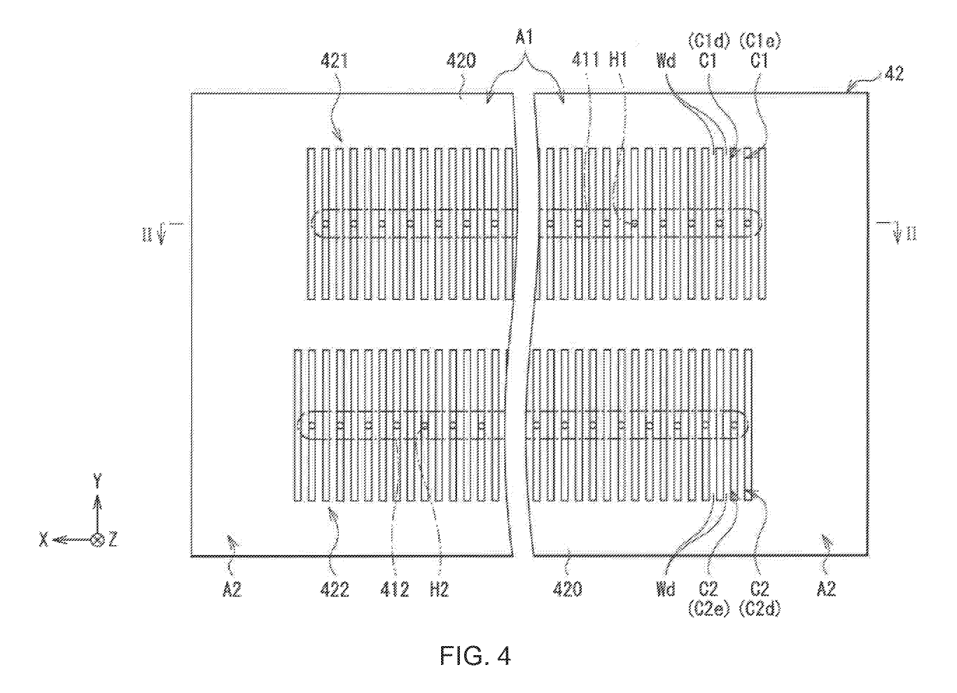

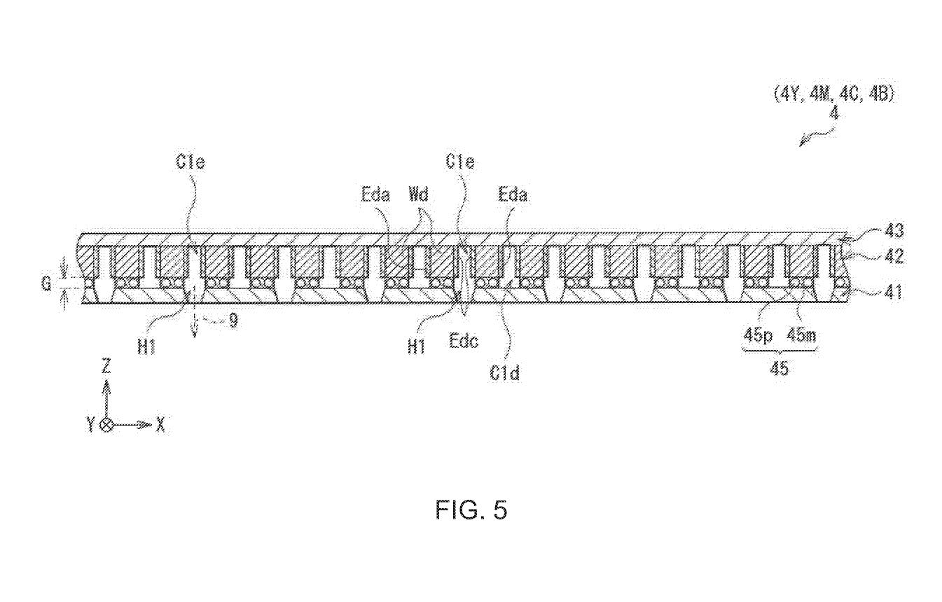

Then, the detailed configuration example of the inkjet heads 4 will be described with reference to FIG. 3 through FIG. 5 in addition to FIG. 1 and FIG. 2. FIG. 3 is an exploded perspective view showing the detailed configuration example of each of the inkjet heads 4. FIG. 4 is a bottom view (an X-Y bottom view) schematically showing a configuration example of the inkjet head 4 in the state in which a nozzle plate 41 (described later) shown in FIG. 3 is detached. FIG. 5 is a diagram schematically showing a cross-sectional configuration example (a Z-X cross-sectional configuration example) along the line II-II shown in FIG. 4.

The inkjet heads 4 according to the present embodiment are each an inkjet head of a so-called side-shoot type for ejecting the ink 9 from a central part in the extending direction (the Y-axis direction) of a plurality of channels (channels C1, C2) described later. Further, the inkjet heads 4 are each an inkjet head of a circulation type which uses the circulation mechanism 5 (the circulation channel 50) described above to thereby use the ink 9 while circulating the ink 9 between the inkjet head 4 and the ink tank 3.

The inkjet head 4 is mainly provided with a nozzle plate (a jet hole plate) 41, an actuator plate 42 and a cover plate 43 (FIG. 3). The nozzle plate 41, the actuator plate 42 and the cover plate 43 are stacked on one another in this order along the Z-axis direction. Between the nozzle plate 41 and the actuator plate 42 opposed to each other, there is disposed an adhesive layer 45 (FIG. 5), and thus, the nozzle plate 41 and the actuator plate 42 are fixed to each other. The adhesive layer (not shown) is also disposed between the actuator plate 42 and the cover plate 43. It should be noted that the description will hereinafter be presented with the cover plate 43 side along the Z-axis direction referred to as an upper side, and the nozzle plate 41 side referred to as a lower side.

### (Nozzle Plate 41)

The nozzle plate 41 is formed of a metal material such as stainless steel, and has a thickness of about 50 μm. As shown in FIG. 3, the nozzle plate 41 is bonded to a lower surface of the actuator plate 42 with the adhesive layer 45. Further, as shown in FIG. 3 and FIG. 4, the nozzle plate 41 is provided with two nozzle columns (nozzle columns 411, 412) each extending along the X-axis direction. These nozzle columns 411, 412 are arranged along the Y-axis direction at a predetermined distance. As described above, the inkjet head 4 of the present embodiment is formed as a tow-column type inkjet head.

The nozzle column 411 has a plurality of nozzle holes H1 formed in alignment with each other at predetermined intervals along the X-axis direction. These nozzle holes H1 each penetrate the nozzle plate 41 along the thickness direction (the Z-axis direction) of the nozzle plate 41, and are communicated with the respective ejection channels C1e in the actuator plate 42 described later as shown in, for example, FIG. 5. Specifically, as shown in FIG. 4, each of the nozzle holes H1 is formed so as to be located in a central part along the Y-axis direction on the ejection channel C1e. Further, the formation pitch along the X-axis direction in the nozzle holes H1 is arranged to be equal (to have an equal pitch) to the formation pitch along the X-axis direction in the ejection channels C1e. Although the details will be described later, it is arranged that the ink 9 supplied from the inside of the ejection channel C1e is ejected (jetted) from each of the nozzle holes H1 in such a nozzle column 411.

The nozzle column 412 similarly has a plurality of nozzle holes H2 formed in alignment with each other at predetermined intervals along the X-axis direction. Each of these nozzle holes H2 also penetrates the nozzle plate 41 along the thickness direction of the nozzle plate 42, and is communicated with the ejection channel C2e in the actuator plate 412 described later. Specifically, as shown in FIG. 4, each of the nozzle holes H2 is formed so as to be located in a central part along the Y-axis direction on the ejection channel C2e. Further, the formation pitch along the X-axis direction in the nozzle holes H2 is arranged to be equal to the formation pitch along the X-axis direction in the ejection channels C2e. Although the details will be described later, it is arranged that the ink 9 supplied from the inside of the ejection channel C2e is also ejected from each of the nozzle holes H2 in such a nozzle column 412.

It should be noted that such nozzle holes H1, H2 are each formed as a tapered through hole gradually decreasing in diameter in a direction toward the lower side, and each correspond to a specific example of a “nozzle” in the present disclosure.

### (Actuator Plate 42)

The actuator plate 42 is a plate formed of a piezoelectric material such as lead zirconate titanate (PZT). The actuator plate 42 is formed by, for example, stacking two piezoelectric substrates different in polarization direction in the Z-axis direction on one another (a so-called chevron type). It is also possible to form the actuator plate 42 with a single piezoelectric substrate having the polarization direction set to one direction along the thickness direction (the Z-axis direction) (a so-called cantilever type). Further, as shown in FIG. 3 and FIG. 4, the actuator plate 42 is provided with two channel columns (channel columns 421, 422) each extending along the X-axis direction. These channel columns 421, 422 are arranged along the Y-axis direction at a predetermined distance. It should be noted that the actuator plate 42 corresponds to a specific example of an “actuator” in the present disclosure.

In such an actuator plate 42, as shown in FIG. 4, an ejection area (jetting area) A1 of the ink 9 is disposed in a central part (the formation areas of the channel columns 421, 422) along the X-axis direction. On the other hand, in the actuator plate 42, a non-ejection area (a non-jetting area) A2 of the ink 9 is disposed in each of the both end parts (non-formation areas of the channel columns 421, 422) along the X-axis direction. The non-ejection areas A2 are located on the outer side along the X-axis direction with respect to the ejection area A1. It should be noted that the both end parts along the Y-axis direction in the actuator plate 42 each constitute a tail part 420.

As shown in FIG. 3 and FIG. 4, the channel column 421 described above has the plurality of channels C1 extending along the Y-axis direction. These channels C1 are arranged side by side so as to be parallel to each other at predetermined intervals along the X-axis direction. Each of the channels C1 is partitioned with drive walls Wd formed of a piezoelectric body (the actuator plate 42), and forms a groove section having a recessed shape in a cross-sectional view (see FIG. 3).

The channel column 422 similarly has the plurality of channels C2 extending along the Y-axis direction. These channels C2 are arranged side by side so as to be parallel to each other at predetermined intervals along the X-axis direction. Each of the channels C2 is also partitioned with the drive walls Wd described above, and forms a groove section having a recessed shape in a cross-sectional view.

Here, as shown in FIG. 3 and FIG. 4, as the channels C1, there exist the ejection channels C1e for ejecting the ink 9, and dummy channels C1d not ejecting the ink 9. In the channel column 421, the ejection channels C1e and the dummy channels C1d are alternately arranged along the X-axis direction. Each of the ejection channels C1e is communicated with the nozzle hole H1 in the nozzle plate 41 on the one hand, but each of the dummy channels C1d is not communicated with the nozzle hole H1, and is covered with the upper surface of the nozzle plate 41 from below on the other hand.

Similarly, as the channels C2, there exist the ejection channels C2e for ejecting the ink 9, and dummy channels C2d not ejecting the ink 9. In the channel column 422, the ejection channels C2e and the dummy channels C2d are alternately arranged along the X-axis direction. Each of the ejection channels C2e is communicated with the nozzle hole H2 in the nozzle plate 41 on the one hand, but each of the dummy channels C2d is not communicated with the nozzle hole H2, and is covered with the upper surface of the nozzle plate 41 from below on the other hand.

Further, as shown in FIG. 4, the ejection channels C1e and the dummy channels C1d in the channels C1 and the ejection channels C2e and the dummy channels C2d in the channels C2 are arranged in a staggered manner. Therefore, in each of the inkjet heads 4 according to the present embodiment, the ejection channels C1e in the channels C1 and the ejection channels C2e in the channels C2 are arranged in a zigzag manner. It should be noted that as shown in FIG. 3, in the actuator plate 42, in the part corresponding to each of the dummy channels C1d, C2d, there is formed a shallow groove section Dd communicated with an outside end part extending along the Y-axis direction in the dummy channel C1d, C2d.

Here, as shown in FIG. 3 and FIG. 5, drive electrodes Ed extending along the Y-axis direction are disposed on the inner side surfaces opposed to each other in each of the drive walls Wd described above. As the drive electrodes Ed, there exist common electrodes Edc disposed on the inner side surfaces facing the ejection channels C1e, C2e, and active electrodes Eda disposed on the inner side surfaces facing the dummy channels C1d, C2d. It should be noted that each of such drive electrodes Ed (the common electrodes Edc and the active electrodes Eda) is formed throughout the entire area in the depth direction (the Z-axis direction) on the inner side surface of the drive wall Wd as shown in FIG. 5. Here, the common electrode Edc corresponds to a specific example of an “electrode” in the present disclosure.

The pair of common electrodes Edc opposed to each other in the same ejection channel C1e (or the same ejection channel C2e) are electrically connected to each other in a common terminal (not shown). Further, the pair of active electrodes Eda opposed to each other in the same dummy channel C1d (or the same dummy channel C2d) are electrically separated from each other. In contrast, the pair of active electrodes Eda opposed to each other via the ejection channel

C1e (or the ejection channel C2e) are electrically connected to each other in an active terminal (not shown).

Here, as shown in FIG. 3, in the tail part 420 described above, there is mounted a flexible printed circuit board 44 for electrically connecting the drive electrodes Ed and a control section (not shown) in the inkjet head 4 to each other. Interconnection patterns (not shown) provided to the flexible printed circuit board 44 are electrically connected to the common terminals and the active terminals described above. Thus, it is arranged that the drive voltage is applied to each of the drive electrodes Ed from the control section via the flexible printed circuit board 44.

### (Adhesive Layer 45)

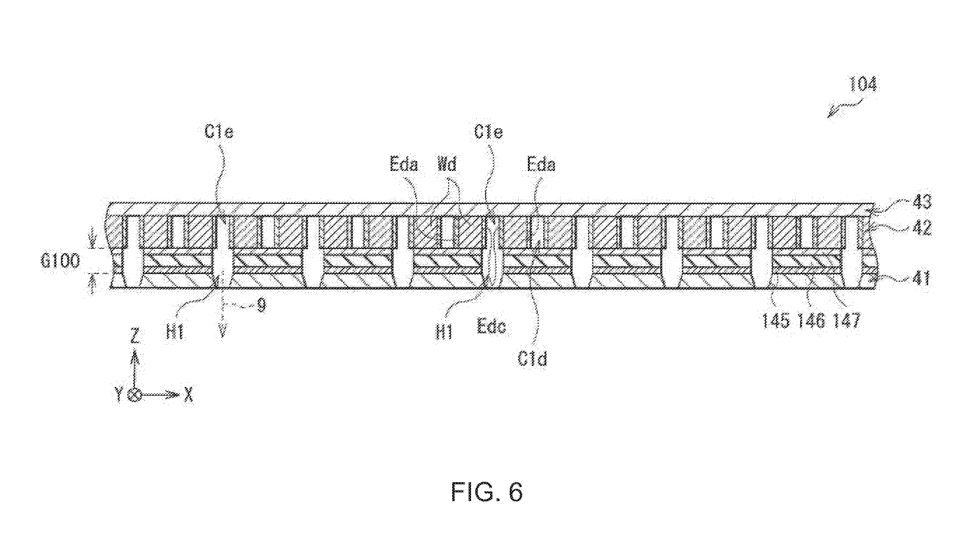

Between the actuator plate 42 and the nozzle plate 41, there is disposed the adhesive layer 45 as shown in FIG. 5. The adhesive layer 45 is for bonding the actuator plate 42 and the nozzle plate 41 to each other, and at the same time for ensuring the insulation property between the actuator plate 42 and the nozzle plate 41, and includes an adhesive 45m and a plurality of insulating particles 45p. Although the details will be described later, in the present embodiment, since the adhesive layer 45 includes the insulating particles 45p as described above, a separate insulating member (an insulating member 146 shown in FIG. 6 described later) from the adhesive layer 45 becomes unnecessary between the actuator plate 42 and the nozzle plate 41. Although the details will be described later, this makes it possible to more simply manufacture the liquid jet head to thereby reduce the cost.

The adhesive layer 45 is disposed in a place other than the ejection channels C1e, C2e and the nozzle holes H1, H2 in order to prevent the adhesive layer 45 from hindering the movement of the ink 9 from the ejection channels C1e, C2e to the nozzle holes H1, H2. Specifically, the adhesive layer 45 is disposed between the drive wall Wd of the actuator plate 42 and a film member of the nozzle plate 41. It is preferable to dispose the adhesive layer 45 in a place other than between the dummy channels C1d, C2d and the nozzle plate 41 in order to prevent the adhesive layer 45 from blocking the dummy channels C1d, C2d. Thus, the drive walls Wd are driven normally.

The adhesive 45m is for bonding the actuator plate 42 and the nozzle plate 41 to each other, and is formed of a resin material such as epoxy resin. It is preferable for the resin material to be able to be controlled to have a viscosity in an appropriate range for forming the smooth adhesive layer 45 small in unevenness. It is preferable for the adhesive 45m to be formed of a material having an insulation property.

The adhesive 45m is provided with a plurality of insulating particles 45p in a dispersed manner, and spaces between the insulating particles 45p are filled with the adhesive 45m. It is preferable that the plurality of insulating particles 45p is disposed in the adhesive 45m (in the adhesive layer 45) so as to evenly be dispersed, and thus, the positional unevenness of density is small. For example, between the actuator plate 42 and the nozzle plate 41, a single layer of the insulating particles 45p is disposed with a roughly uniform density distribution. At least some of the plurality of insulating particles 45p have contact with both of the actuator plate 42 and the nozzle plate 41. For example, the distance (a gap G) between the actuator plate 42 and the nozzle plate 41 is roughly the same as the particle size of the insulating particles 45p, and a large majority of the insulating particles 45p have contact with both of the actuator plate 42 and the nozzle plate 41. Since the insulating particles 45p have contact with both of the actuator plate 42 and the nozzle plate 41 as described above, it is possible to keep a certain distance (the gap G) between the actuator plate 42 and the nozzle plate 41 in accordance with the particle size of the insulating particles 45p. As a result, the insulation property between the drive electrodes Ed provided to the actuator plate 42 and the nozzle plate including the metal material is reliably maintained. Further, it is possible to easily control the gap G between the actuator plate 42 and the nozzle plate 41 using the particle size of the insulating particles 45p.

The plurality of insulating particles 45p each has, for example, a spherical shape. In the case of the insulating particles 45p each having the spherical shape, since the gap G between the actuator plate 42 and the nozzle plate 41 is kept constant regardless of the posture with which the insulating particle 45p is disposed, it becomes easy to adjust the gap G. The insulating particles 45p each having the spherical shape include not only completely spherical particles, but also spherical particles having distortion in a range in which the advantage described above is exerted.

It is preferable for the particle size of the plurality of insulating particles 45p to be in a range of 1 μm through 10 μm. By making the particle size of the insulating particles 45p equal to or larger than 1 μm, it becomes easy to ensure the insulation property between the actuator plate 42 and the nozzle plate 41. Further, by making the particle size of the insulating particles 45p equal to or smaller than 10 μm, it is possible to prevent defects in forming the adhesive layer 45 from occurring. Specifically, as the defects in forming the adhesive layer 45, there can be cited separation by a transfer squeegee, leakage of the insulating particles 45p, and so on. It is preferable for the plurality of insulating particles 45p in the adhesive layer 45 to have a uniform particle size. By providing the uniform particle size to the plurality of insulating particles 45p, it is possible to reliably insulate a space between the actuator plate 42 and the nozzle plate 41, and at the same time to control the space to be the uniform gap G. Therefore, it becomes possible to improve flatness and smoothness of the nozzle plate 41.

The insulating particles 45p are formed of a material having chemical resistance and heat resistance. For example, as the insulating particles 45p, it is possible to use gap controlling particles. The insulating particles 45p are formed of, for example, resin, glass, or silica.

The adhesive layer 45 is formed in, for example, the following manner. Firstly, the insulating particles 45p are added to a constituent material of the adhesive 45m, and then the constituent material is agitated. On this occasion, it is preferable to agitate the constituent material so that the insulating particles 45p are evenly dispersed in the adhesive 45m. Then, the adhesive 45m added with the insulating particles 45p is applied on the surface of the actuator plate 42 using the transfer squeegee. Subsequently, the nozzle plate 41 is made to adhere to the actuator plate 42 coated with the adhesive 45m, and then the adhesive 45m is made to cure. It is also possible to use the thermosetting adhesive 45m to make the adhesive 45m cure by heating. In such a manner, the adhesive layer 45 is formed. It is also possible to perform the addition of the insulating particles 45p after applying the adhesive 45m to the surface of the actuator plate 42. It is also possible to apply the adhesive 45m on the surface of the nozzle plate 41, but it is preferable to apply the adhesive 45m to the surface of the actuator plate 42. When applying the adhesive 45m to the surface of the actuator plate 42, it is possible to selectively apply the adhesive 45m to the part except the channels C1, C2. Therefore, it is possible to prevent the adhesive layer 45 from entering the nozzle holes H1, H2.

### (Cover Plate 43)

As shown in FIG. 3, the cover plate 43 is disposed so as to close the channels C1, C2 (the channel columns 421, 422) in the actuator plate 42. Specifically, the cover plate 43 is bonded to the upper surface of the actuator plate 42, and has a plate-like structure.

As shown in FIG. 3, the cover plate 43 is provided with a pair of entrance side common ink chambers 431a, 432a and a pair of exit side common ink chambers 431b, 432b. Specifically, the entrance side common ink chamber 431a and the exit side common ink chamber 431b are each formed in an area corresponding to the channel column 421 (the plurality of channels C1) in the actuator plate 42. Further, the entrance side common ink chamber 432a and the exit side common ink chamber 432b are each formed in an area corresponding to the channel column 422 (the plurality of channels C2) in the actuator plate 42.

The entrance side common ink chamber 431a is formed in the vicinity of an inner end part along the Y-axis direction in each of the channels C1, and forms a groove section having a recessed shape. In areas corresponding respectively to the ejection channels C1e in the entrance side common ink chamber 431a, there are respectively formed supply slits Sa penetrating the cover plate 43 along the thickness direction (the Z-axis direction) of the cover plate 413. Similarly, the entrance side common ink chamber 432a is formed in the vicinity of an inner end part along the Y-axis direction in each of the channels C2, and forms a groove section having a recessed shape. In this entrance side common ink chamber 432a, the supply slit Sa described above is also formed in an area corresponding to each of the ejection channels C2e.

As shown in FIG. 3, the exit side common ink chamber 431b is formed in the vicinity of an outer end part along the Y-axis direction in each of the channels C1, and forms a groove section having a recessed shape. In areas corresponding respectively to the ejection channels C1e in the exit side common ink chamber 431b, there are respectively formed discharge slits Sb penetrating the cover plate 43 along the thickness direction of the cover plate 413. Similarly, the exit side common ink chamber 432b is formed in the vicinity of an outer end part along the Y-axis direction in each of the channels C2, and forms a groove section having a recessed shape. In this exit side common ink chamber 432b, the discharge slit Sb described above is also formed in an area corresponding to each of the ejection channels C2e.

In such a manner, the entrance side common ink chamber 431a and the exit side common ink chamber 431b are each communicated with the ejection channel C1e via the supply slit Sa and the discharge slit Sb on the one hand, but are not communicated with the dummy channels C1d on the other hand. Specifically, each of the dummy channels C1d is arranged to be closed by bottom parts of the entrance side common ink chamber 431a and the exit side common ink chamber 431b.

Similarly, the entrance side common ink chamber 432a and the exit side common ink chamber 432b are each communicated with the ejection channel C2e via the supply slit Sa and the discharge slit Sb on the one hand, but are not communicated with the dummy channels C2d on the other hand. Specifically, each of the dummy channels C2d is arranged to be closed by bottom parts of the entrance side common ink chamber 432a and the exit side common ink chamber 432b.

### [Operations and Functions/Advantages]

### (A. Basic Operation of Printer 1)

In the printer 1, a recording operation (a printing operation) of images, characters, and so on to the recording paper P is performed in the following manner. It should be noted that as an initial state, it is assumed that the four types of ink tanks 3 (3Y, 3M, 3C, and 3B) shown in FIG. 1 are sufficiently filled with the ink 9 of the corresponding colors (the four colors), respectively. Further, there is achieved the state in which the inkjet heads 4 are filled with the ink 9 in the ink tanks 3 via the circulation mechanism 5, respectively.

In such an initial state, when operating the printer 1, the grit rollers 21 in the carrying mechanisms 2a, 2b rotate to thereby carry the recording paper P along the carrying direction d (the X-axis direction) between the grit rollers 21 and the pinch rollers 22. Further, at the same time as such a carrying operation, the drive motor 633 in the drive mechanism 63 respectively rotates the pulleys 631a, 631b to thereby operate the endless belt 632. Thus, the carriage 62 reciprocates along the width direction (the Y-axis direction) of the recording paper P while being guided by the guide rails 61a, 61b. Then, on this occasion, the four colors of ink 9 are appropriately ejected on the recording paper P by the respective inkjet heads 4 (4Y, 4M, 4C, and 4B) to thereby perform the recording operation of images, characters, and so on to the recording paper P.

### (B. Detailed Operation in Inkjet Heads 4)

Then, the detailed operation (the jet operation of the ink 9) in the inkjet head 4 will be described with reference to FIG. 1 through FIG. 5. Specifically, in the inkjet heads 4 (the side-shoot type, the circulation type inkjet heads) according to the present embodiment, the jet operation of the ink 9 using a shear mode is performed in the following manner.

Firstly, when the reciprocation of the carriage 62 (see FIG. 1) described above is started, a control section applies the drive voltages to the drive electrodes Ed (the common electrodes Edc and the active electrodes Eda) in the inkjet head 4 via the flexible printed circuit board 44. Specifically, the control section applies the drive voltage to the drive electrodes Ed disposed on the pair of drive walls Wd forming the ejection channel C1e, C2e. Thus, the pair of drive walls Wd each deform (see FIG. 5) so as to protrude toward the dummy channel C1d, C2d adjacent to the ejection channel C1e, C2e.

Here, as described above, in the actuator plate 42, the polarization direction differs along the thickness direction (the two piezoelectric substrates described above are stacked on one another), and at the same time, the drive electrode Ed is formed in the entire area in the depth direction on the inner side surface in each of the drive walls Wd. Therefore, by applying the drive voltage using the control section, it results that the drive wall Wd makes a flexion deformation to have a V shape centered on the intermediate position in the depth direction in the drive wall Wd. Further, due to such a flexion deformation of the drive wall Wd, the ejection channel C1e, C2e deforms as if the ejection channel C1e, C2e bulges.

In the case in which the configuration of the actuator plate 42 is not the chevron type but is the cantilever type described above, the drive wall Wd makes the flexion deformation to have the V shape in the following manner. That is, in the case of the cantilever type, since it results that the drive electrode Ed is attached by the oblique evaporation to an upper half in the depth direction, by the drive force exerted only on the part provided with the drive electrode Ed, the drive wall Wd makes the flexion deformation (in the end part in the depth direction of the drive electrode Ed). As a result, even in this case, since the drive wall Wd makes the flexion deformation to have the V shape, it results that the ejection channel C1e, C2e deforms as if the ejection channel C1e, C2e bulges.

As described above, due to the flexion deformation caused by a piezoelectric thickness-shear effect in the pair of drive walls Wd, the capacity of the ejection channel C1e, C2e increases. Further, due to the increase of the capacity of the ejection channel C1e, C2e, it results that the ink 9 retained in the entrance side common ink chamber 431a, 432a is induced into the ejection channel C1e, C2e (see FIG. 3).

Subsequently, the ink 9 having been induced into the ejection channel C1e, C2e in such a manner turns to a pressure wave to propagate to the inside of the ejection channel C1e, C2e. Then, the drive voltage to be applied to the drive electrodes Ed becomes 0 (zero) V at the timing at which the pressure wave has reached the nozzle hole H1, H2 of the nozzle plate 41. Thus, the drive walls Wd are restored from the state of the flexion deformation described above, and as a result, the capacity of the ejection channel C1e, C2e having once increased is restored again (see FIG. 5).

When the capacity of the ejection channel C1e, C2e is restored in such a manner, the internal pressure of the ejection channel C1e, C2e increases, and the ink 9 in the ejection channel C1e, C2e is pressurized. As a result, the ink 9 having a droplet shape is ejected (see FIG. 5) toward the outside (toward the recording paper P) through the nozzle hole H1, H2. The jet operation (the ejection operation) of the ink 9 in the inkjet head 4 is performed in such a manner, and as a result, the recording operation of images, characters, and so on to the recording paper P is performed.

In particular, the nozzle holes H1, H2 of the present embodiment each have the tapered shape gradually decreasing in diameter in the downward direction (see FIG. 5) as described above, and can therefore eject the ink 9 straight (good in straightness) at high speed. Therefore, it becomes possible to perform recording high in image quality.

### (C. Functions/Advantages)

In the inkjet heads 4 according to the present embodiment, since the adhesive layer 45 between the actuator plate 42 and the nozzle plate 41 includes the insulating particles 45p, the insulation property between the drive electrodes Ed provided to the actuator plate 42 and the nozzle plate 41 including the metal material is maintained. Therefore, a separate insulating member (the insulating member 146 shown in FIG. 6 described later) from the adhesive layer 45 becomes unnecessary. Hereinafter, this point will be described in detail in comparison with a comparative example.

### COMPARATIVE EXAMPLE

FIG. 6 shows a schematic cross-sectional configuration of a principal part of an inkjet head (an inkjet head 104) related to the comparative example. This inkjet head 104 has a sheet-like insulating member (the insulating member 146) located between the actuator plate 42 and the nozzle plate 41. The insulating member 146 is bonded to each of the nozzle plate 41 and the actuator plate 42 with the adhesive layers 145, 147. The adhesive layers 145, 147 do not include insulating particles (the insulating particles 45p shown in FIG. 5), and the insulation property between the drive electrodes Ed provided to the actuator plate 42 and the nozzle plate 41 including the metal material is ensured by the insulating member 146.

The process of manufacturing such an inkjet head 104 includes a process of bonding the insulating member 146 to the actuator plate 42 via the adhesive layer 147, and a process of bonding the nozzle plate 41 to the insulating member 146 via the adhesive layer 145. In other words, in order to make the insulating member intervene between the actuator plate 42 and the nozzle plate 41, it becomes necessary to perform the bonding process twice. Due to the bonding process performed twice, the manufacturing time becomes long. Further, the material cost of the insulating member 146 also arises.

Further, if the two adhesive layers (the adhesive layers 145, 147) exist between the actuator plate 42 and the nozzle plate 41, the distance (a gap G100) between the actuator plate 42 and the nozzle plate 41 is not fixed, and it is difficult to maintain the flatness and the smoothness of the nozzle plate 41. Specifically, when forming the adhesive layers 145, 147, rucks or the like occur in the insulating member 146 under the influence of the viscosity of the adhesive, a difference in degree of expansion and contraction and curing time between the different materials, and so on. Thus, it becomes difficult to maintain the flatness and the smoothness of the nozzle plate 41. The flatness and the smoothness of the nozzle plate 41 affect the ejection accuracy.

In addition, since the distance (the gap G100) between the actuator plate 42 and the nozzle plate 41 is a sum of the thickness of the insulating member 146, the thickness of the adhesive layer 145 and the thickness of the adhesive layer 147, it is difficult to reduce the gap G100 in manufacturing. If the gap G100 is large, the distance between the internal space of the ejection channel C1e, C2e and the nozzle hole (the nozzle hole H1, H2 shown in FIG. 3) becomes long, and it becomes difficult for the ejection pressure of the ink to be transferred toward the nozzle hole H1, H2. Therefore, there is a possibility that degradation of the image quality such as degradation of the landing position accuracy occurs due to the size of the gap G100.

### Present Embodiment

In contrast, in the present embodiment, the adhesive layer 45 between the actuator plate 42 and the nozzle plate 41 includes the insulating particles 45p, and the insulation property between the actuator plate 42 and the nozzle plate 41 is maintained by the insulating particles 45p. Therefore, the insulating member (the insulating member 146 shown in FIG. 6) becomes unnecessary. Thus, the number of times of the bonding process between the actuator plate 42 and the nozzle plate 41 becomes one (the formation process of the adhesive layer 45 described above), and it is possible to reduce the number of the processes and the manufacturing time compared to the comparative example. Therefore, it is possible to more simply perform the manufacturing. Further, the material cost due to the insulating member also becomes unnecessary. Therefore, in the manufacturing method and the material cost, it is possible to reduce the cost.

Further, since a single adhesive layer 45 is disposed alone between the actuator plate 42 and the nozzle plate 41, it is easy to fix the gap G corresponding to the particle size of the insulating particles 45p, and it is possible to improve the flatness and the smoothness of the nozzle plate 41. Therefore, the ejection accuracy can be improved.

In addition, since the gap G does not include the thickness of the insulating member, but corresponds to the thickness of the adhesive layer 45 alone, and is therefore, easy to decrease. Further, the gap G can easily be controlled using the particle size of the insulating particles 45p. Therefore, it becomes possible to improve the landing position accuracy, and by extension, to improve the image quality with the gap G smaller in size.

As described above, in the inkjet head 4 and the printer 1 according to the present embodiment, since the adhesive layer 45 between the actuator plate 42 and the nozzle plate 41 includes the insulating particles 45p, the separate insulating member (the insulating member 146 shown in FIG. 6) from the adhesive layer 45 becomes unnecessary. Thus, the number of the processes and the manufacturing time decrease. Therefore, it becomes possible to more simply manufacture the liquid jet head to thereby reduce the cost. Further, since the material cost due to the insulating member also becomes unnecessary, it is possible to reduce the cost in terms of the material cost.

Further, since the adhesive layer 45 alone is disposed between the actuator plate 42 and the nozzle plate 41, the flatness and the smoothness of the nozzle plate 41 are improved compared to the inkjet head 104 including the two adhesive layers 145, 147. Thus, the ejection accuracy can be improved.

In addition, since it is possible to easily reduce the gap G between the actuator plate 42 and the nozzle plate 41, it becomes possible to improve the image quality such as landing position accuracy.

Further, in the case of the insulating particles 45p each having the spherical shape, since the gap G is kept constant regardless of the posture of the particle arranged, it becomes easier to adjust the gap G.

### 2. Modified Examples

The shape of each of the insulating particles 45p included in the adhesive layer 45 can also be other shapes than the spherical shape.

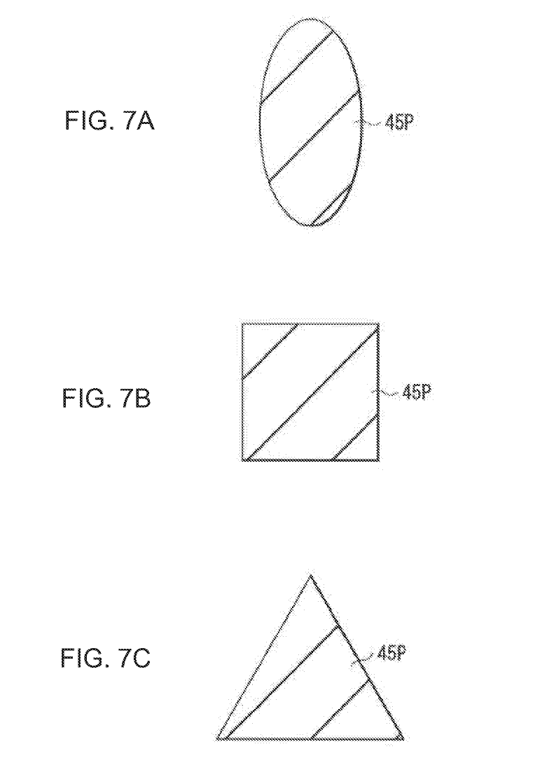

FIG. 7A through FIG. 7C are diagrams each showing an example of the cross-sectional configuration of the insulating particle 45p having a different shape from the spherical shape. It is also possible for the insulating particle 45p to have a shape such as a prolate spheroidal (rugby ball) shape, and to have an elliptical cross-sectional shape (FIG. 7A). It is also possible for the insulating particle 45p to have a shape such as a cube or a rectangular solid, and to have a quadrangular cross-sectional shape (FIG. 7B). It is also possible for the insulating particle 45p to have a shape such as a triangular prism or a triangular pyramid, and to have a triangular cross-sectional shape (FIG. 7C). The cross-sectional shape of the insulating particle 45p can also be a polygon other than a triangle and a quadrangle.

It is also possible for the insulating particles 45p each having the spherical shape and the insulating particles 45p each having a different shape from the spherical shape to exist in the adhesive layer 45 in a mixed manner, or it is also possible for all of the insulating particles 45p included in the adhesive layer 45 to have a different shape from the spherical shape.

The insulating particles 45p having other shapes than the spherical shape are difficult to rotate compared to the insulating particles 45p having the spherical shape, and can therefore prevent the displacement of the insulating particles 45p before the adhesive 45m cures when forming the adhesive layer 45. Therefore, in the adhesive layer 45 including the insulating particles 45p each having other shapes than the spherical shape, it becomes easy to keep the arrangement of the insulating particles 45p dispersed evenly.

### 3. Other Modified Examples

The disclosure is described hereinabove citing the embodiment, but the disclosure is not limited to the embodiment, and a variety of modifications can be adopted.

For example, in the embodiment described above, the description is presented specifically citing the configuration examples (the shapes, the arrangements, the number and so on) of each of the members in the printer 1 and the inkjet head 4, but what is described in the above embodiment is not a limitation, and it is possible to adopt other shapes, arrangements, numbers and so on. Further, the values or the ranges, the magnitude relation and so on of a variety of parameters described in the above embodiment are not limited to those described in the above embodiment, but can also be other values or ranges, other magnitude relation and so on.

Specifically, for example, in the embodiment described above, the description is presented citing the inkjet head 4 of the two column type (having the two nozzle columns 411, 412), but the example is not a limitation. Specifically, for example, it is also possible to adopt an inkjet head of a single column type (having a single nozzle column), or an inkjet head of a multi-column type (having three or more nozzle columns) with three or more columns.

Further, for example, in the embodiment described above, there is described the case in which the nozzle columns 411, 412 each extend linearly along the X-axis direction, but this example is not a limitation. It is also possible to arrange that, for example, the nozzle columns 411, 412 each extend in an oblique direction. Further, the shape of each of the nozzle holes H1, H2 is not limited to the circular shape as described in the above embodiment, but can also be, for example, a polygonal shape such as a triangular shape, an elliptical shape, or a start shape.

Further, in the embodiment described above, the example of the so-called side-shoot type inkjet head for ejecting the ink 9 from the central part in the extending direction of the ejection channels C1e, C2e is described, but the example is not a limitation. Specifically, it is also possible to apply the present disclosure to a so-called edge-shoot type inkjet head for ejecting the ink 9 along the extending direction of the ejection channels C1e, C2e.

Further, the shape, the size, the constituent material and so on of the insulating particles 45p are not limited to those described in the above embodiment, but can also be other shapes, sizes, constituent materials and so on.

Further, in the above embodiment, the description is presented citing the printer 1 (the inkjet printer) as a specific example of the “liquid jet recording device” in the present disclosure, but this example is not a limitation, and it is also possible to apply the present disclosure to other devices than the inkjet printer. In other words, it is also possible to arrange that the “liquid jet head” (the inkjet head 4) of the present disclosure is applied to other devices than the inkjet printer. Specifically, for example, it is also possible to arrange that the “liquid jet head” of the present disclosure is applied to a device such as a facsimile or an on-demand printer.

Further, it is also possible to apply the variety of examples described hereinabove in arbitrary combination.

It should be noted that the advantages described in the specification are illustrative only but are not a limitation, and another advantage can also be provided.

The present disclosure may be embodied as described below.

<1>

A liquid jet head comprising a nozzle plate provided with a nozzle; an actuator disposed so as to be opposed to the nozzle plate, and having a channel communicated with the nozzle and an electrode disposed on a wall surface of the channel; and an adhesive layer disposed between the actuator and the nozzle plate, and including a plurality of insulating particles.

<2>

The liquid jet head according to <1>, wherein at least some of the plurality of insulating particles have contact with both of the actuator and the nozzle plate.

<3>

The liquid jet head according to <1> or <2>, wherein at least some of the plurality of insulating particles are spherical bodies.

<4>

The liquid jet head according to any one of <1> to <3>, wherein at least some of insulating particles have a different shape from the spherical body.

<5>

The liquid jet head according to any one of <1> to <4>, wherein the insulating particles include one of resin, glass, and silica.

<6>

The liquid jet head according to any one of <1> to <5>, wherein a particle size of the insulating particles is in a range of 1 μm through 10 μm.

<7>

A liquid jet recording device comprising the liquid jet head according to any one of <1> to <6>.

What is claimed is:

1. A liquid jet head comprising:
a nozzle plate provided with a nozzle;
an actuator disposed so as to be opposed to the nozzle plate, and having a channel communicated with the nozzle and an electrode disposed on a wall surface of the channel; and
an adhesive layer disposed between the actuator and the nozzle plate, and including a plurality of insulating particles.

2. The liquid jet head according to claim 1, wherein
at least some of the plurality of insulating particles have contact with both of the actuator and the nozzle plate.

3. The liquid jet head according to claim 1, wherein
at least some of the plurality of insulating particles are spherical bodies.

4. The liquid jet head according to claim 1, wherein
at least some of insulating particles have a different shape from the spherical body.

5. The liquid jet head according to claim 1, wherein
the insulating particles include one of resin, glass, and silica.

6. The liquid jet head according to claim 1, wherein
a particle size of the insulating particles is in a range of 1 μm through 10 μm.

7. A liquid jet recording device comprising the liquid jet head according to claim 1.
